(19) United States
(12) Patent Application Publication
(10) Pub. No.: US 2012/0254397 A1
(43) Pub. Date: Oct. 4, 2012

(54) Method and System for Frame Discard on Switchover of Traffic Manager Resources

(75) Inventors: Ali Zaringhalam, North Caldwell, NJ (US); Richard Charles Boelens, Grand View, NY (US); Stephen J. Brolin, Livingston, NJ (US)

(73) Assignee: FUJITSU NETWORK COMMUNICATIONS, INC., Richardson, TX (US)

(21) Appl. No.: 13/076,175

(22) Filed: Mar. 30, 2011

(51) Int. Cl. G06F 15/173

(52) U.S. Cl. 709/224

(57) ABSTRACT

In accordance with some embodiments of the present disclosure, a method may include receiving a plurality of frames in a flow from a plurality of traffic managers, determining whether a traffic manager from which a frame in the flow was sent is a primary traffic manager for the flow or a secondary traffic manager for the flow based on a class marker for the frame, switching the frame if the frame is from the primary traffic manager for the flow, and discarding the frame if the frame is from the secondary traffic manager for the flow.

### TECHNICAL FIELD OF THE DISCLOSURE

The present disclosure relates generally to networked communications and, more particularly, to a method and system for discarding frames on switchover of traffic manager resources.

### BACKGROUND

A communication network may include network elements that route packets and/or frames through the network. Some network elements may include a distributed architecture, wherein frame processing may be distributed among several subsystems of the network element (e.g., line cards, switches, and traffic managers). In some instances, a network element used in a communication network may be a multi-function Ethernet aggregation network element. A multi-function Ethernet aggregation network element may be one which supports many functions, including without limitation link aggregation, virtual LAN (VLAN) detection, and traffic management/shaping.

A multi-function Ethernet aggregation network element may include a distributed architecture including one or more plug-in units (PIUs). A PIU may comprise a modular electronic device that provides any suitable network communication functionality. For example, a PIU may include, among other things, a switch (e.g., an Ethernet switch) for switching traffic through the network element and a traffic manager for shaping and/or policing network flows.

### SUMMARY

In accordance with some embodiments of the present disclosure, a method may include a method may include receiving a plurality of frames in a flow from a plurality of traffic managers, determining whether a traffic manager from which a frame in the flow was sent is a primary traffic manager for the flow or a secondary traffic manager for the flow based on a class marker for the frame, switching the frame if the frame is from the primary traffic manager for the flow, and discarding the frame if the frame is from the secondary traffic manager for the flow.

One or more other technical advantages of the disclosure may be readily apparent to one skilled in the art from the figures, descriptions, and claims included herein.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates a block diagram of an example communication network, in accordance with certain embodiments of the present disclosure;

FIG. 2 illustrates a block diagram of an example network element, in accordance with certain embodiments of the present disclosure;

FIG. 3 illustrates a block diagram of portions of an example network element including the path of a flow subject to a switchover of traffic manager resources as the network element transitions from one-PIU operation to two-PIU operation, in accordance with certain embodiments of the present disclosure; and

FIG. 4 illustrates a flow chart depicting an example method for discarding Ethernet frames after a network element transitions from one-PIU operation to two-PIU operation.

### DETAILED DESCRIPTION

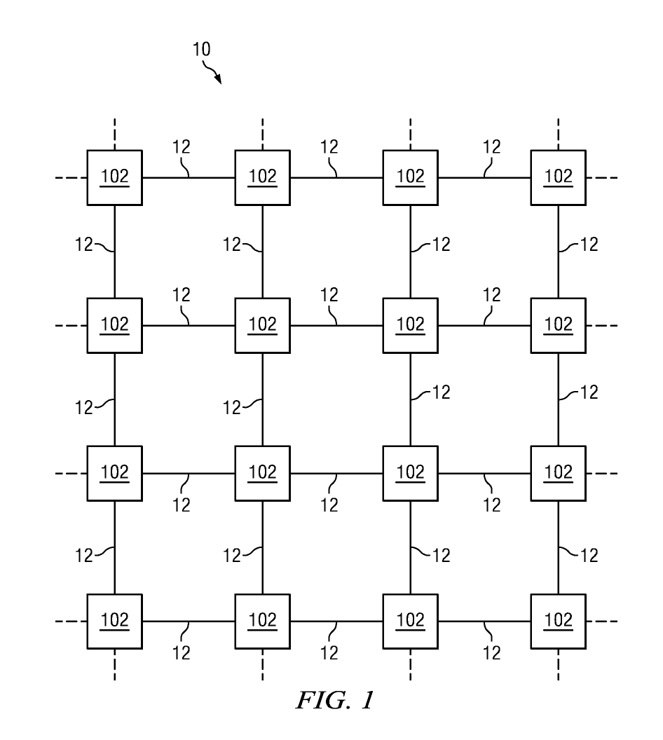

FIG. 1 illustrates a block diagram of an example network 10, in accordance with certain embodiments of the present disclosure. Network 10 may include one or more transmission media 12 operable to transport one or more signals communicated by components of network 10. In certain embodiments, network 10 may carry Ethernet signals. The components of network 10, coupled together by transmission media 12, may include a plurality of network elements 102. In the illustrated network 10, each network element 102 is coupled to four other nodes. However, any suitable configuration of any suitable number of network elements 102 may create network 10. Although network 10 is shown as a mesh network, network 10 may also be configured as a ring network, a point-to-point network, or any other suitable network or combination of networks. Network 10 may be used in a short-haul metropolitan network, a long-haul inter-city network, or any other suitable network or combination of networks.

Each transmission medium 12 may include any system, device, or apparatus configured to communicatively couple network elements 102 to each other and communicate information between corresponding network elements 102. For example, a transmission medium 12 may include an optical fiber, an Ethernet cable, a T1 cable, a WiFi signal, a Bluetooth signal, or other suitable medium.

Network 10 may communicate information or “traffic” over transmission media 12. As used herein, “traffic” means information transmitted, stored, or sorted in network 10. Such traffic may comprise optical or electrical signals configured to encode audio, video, textual, and/or any other suitable data. The data may also be real-time or non-real-time. Traffic may be communicated via any suitable communications protocol, including, without limitation, the Ethernet communication protocol and the Internet Protocol (IP). Additionally, the traffic communicated in network 10 may be structured in any appropriate manner including, but not limited to, being structured in frames, packets, or an unstructured bit stream. As used herein, a “flow” may mean a sequence of packets, frames, cells, or any other segments of data communicated over a network.

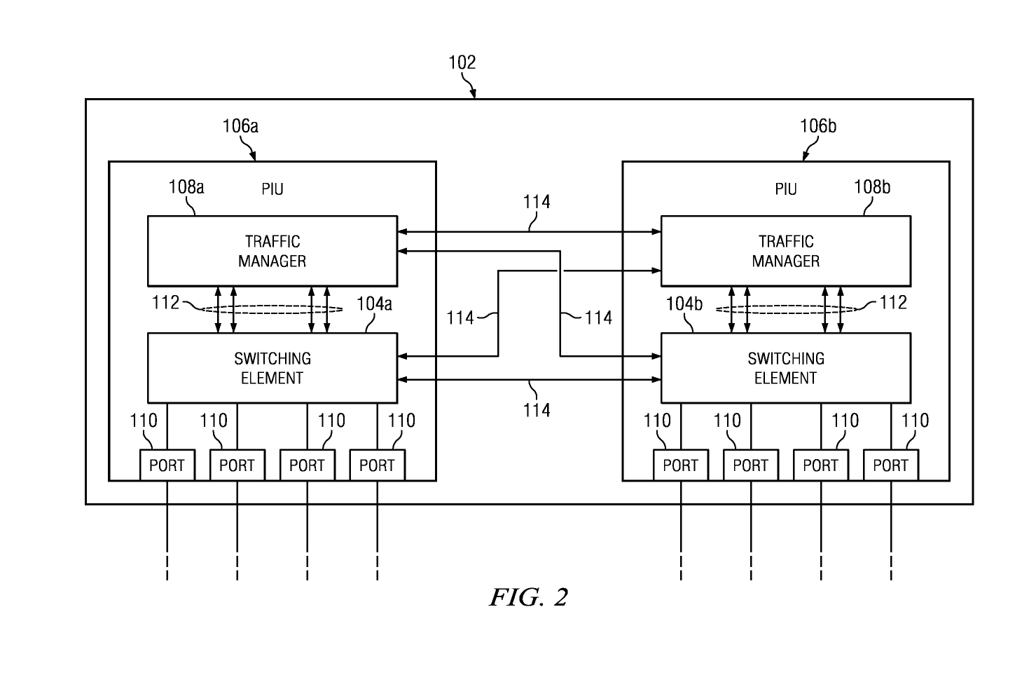

Each network element 102 in network 10 may comprise any suitable system operable to transmit and receive traffic. In the illustrated embodiment, each network element 102 may be operable to transmit traffic directly to one or more other network elements 102 and receive traffic directly from the one or more other network elements 102. Network elements 102 will be described in more detail below with respect to FIG. 2.

Modifications, additions, or omissions may be made to network 10 without departing from the scope of the disclosure. The components and elements of network 10 described may be integrated or separated according to particular needs. Moreover, the operations of network 10 may be performed by more, fewer, or other components.

FIG. 2 illustrates a block diagram of certain embodiments of network element 102, in accordance with certain embodiments of the present disclosure. As described above, each network element 102 may be coupled to one or more other network elements 102 via one or more transmission media 12. Each network element 102 may generally be configured to receive data from and/or transmit data to one or more other network elements 102. In certain embodiments, network element 102 may comprise a switch configured to route data received by network element 102 to another device coupled to network element 102 (e.g., another network element 102 or one or more devices or clients coupled to the network element 102).

As depicted in FIG. 2, a network element 102 may include a plurality of plug-in units (PIU) 106 with a plurality of ports 110 and one or more inter-PIU links 114. In some embodiments, ports 110 may be coupled to other components within network element 102. For example, an optical receiver in network element 102 may receive traffic in optical form from transmission line 12 and convert the traffic into electrical form, allowing the traffic to be communicated from the optical receiver to PIU 106 via port 110.

A PIU 106 may include any system, device, or apparatus having plug-in terminals so that some or all electrical connections of the PIU 106 can be made engaging the unit with a suitable socket of network element 102. A PIU may include any system, device, or apparatus or combination thereof to implement networking functions. As shown in FIG. 2, one example of a PIU 106 may include a switching element 104, a traffic manager 108, intra-PIU links 112, and a plurality of ports 110.

A port 110 may be communicatively coupled to a switching element 104 and may include any suitable system, apparatus, or device configured to serve as an interface between a switching element 104 and other devices within network element 102. A port 110 may be implemented using hardware, software, or any combination thereof. For example, a port 110 may comprise an Ethernet port or any other suitable port. Some of ports 110 may be interfaced to clients of a network provider (e.g., devices or networks, other than network elements 102, that are coupled to the network element 102), while other of ports 110 may be interfaced to the provider network (e.g., other network elements 102).

An intra-PIU link 112 may include any system, device, or apparatus configured to communicatively couple a switching element 104 to a traffic manager 108 and communicate information between a switching element 104 and its corresponding traffic manager 108. For example, an intra-PIU link 112 may include a metal wire, a printed wiring board path, or other suitable medium.

An inter-PIU link 114 may include any system, device, or apparatus configured to communicatively couple a switching element 104 or traffic manager 108 of one PIU 106 to a switching element 104 or traffic manager 108 of another PIU 106 and communicate information between the corresponding devices. For example, an inter-PIU link 114 may include a metal wire, paths on a backplane wiring board of network element 102, or other suitable medium.

A switching element 104 may include any suitable system, apparatus, or device configured to receive ingress traffic via a port 110 and route such traffic to a particular egress port 110 based on analyzing the contents of the data (e.g., a destination address of a frame of traffic). For example, switching element 104 may comprise an Ethernet switch for switching Ethernet traffic through network element 102.

A traffic manager 108 may be communicatively coupled to switching element 104 on the same PIU 106 via intra-PIU links 112, and may include any suitable system, apparatus, or device configured to police and/or shape flows of traffic. Traffic shaping is the control of traffic flows in order to optimize or guarantee performance, improve latency, and/or increase usable bandwidth by delaying frames of traffic that meet certain criteria. More specifically, traffic shaping is any action on a flow of frames which manages the frames such that they conform to some predetermined constraint (e.g., a service-level agreement or traffic profile). Traffic policing is the process of monitoring network traffic for compliance with a service-level agreement and taking action to enforce such agreement. For example, in traffic policing, traffic exceeding a service-level agreement may be discarded immediately, marked as non-compliant, or left as-is, depending on an administrative policy and the characteristics of the excess traffic.

As illustrated in FIG. 2, some embodiments of network element 102 may include two PIUs 106. A distribution of traffic management tasks among two or more traffic managers 108 in a two-PIU system may be desirable to increase bandwidth as well as to provide redundancy. Accordingly, in a two-PIU system, traffic manager resources, including but not limited to policers, shapers, and egress buffers, may be physically duplicated.

In a two-PIU network element 102, a first traffic manager 108a on a first PIU 106a may handle some flows, and a second traffic manager 108b on a second PIU 106b may handle other flows during normal two-PIU operation. For example, in some embodiments, during two-PIU operation in network element 102, traffic manger 108a may normally handle, among other flows, all upstream traffic received on both PIU 106a and PIU 106b that was communicated from a client via fiber optic transmission lines. Similarly, a traffic manger 108b may normally handle, among other flows, all upstream traffic received on both PIU 106a and PIU 106b that was communicated from a client via copper wire transmission lines. In some embodiments, the distribution of flows or groups of flows between traffic manager 108a and 108b may be based on criteria other than whether the traffic was transmitted via fiber optic transmission lines or copper wire transmission lines.

Network element 102 may also be configured to handle a switchover of traffic manager resources in response to an administrator request or due to system conditions. Examples of system conditions that may cause a switchover of traffic manager resources may include the removal and subsequent re-insertion of one of the two PIUs in network element 102. For example, if PIU 106b is removed from network element 102, network element 102 may enter one-PIU operation with PIU 106a. During one-PIU operation caused by the removal of PIU 106b, traffic manager 108a in PIU 106a may handle, among other flows, the upstream traffic that is received on PIU 106a but would normally be directed to traffic manager 106b for processing during two-PIU operation. For example, traffic manager 108a may handle, among other flows, all upstream traffic received by PIU 106a that was communicated from a client via copper transmission lines. Upon the re-insertion of PIU 106b, network element 102 may return to two-PIU operation, and upstream traffic normally handled by traffic manager 108b may again be directed to traffic manager 108b. For example, upstream traffic from copper clients received on PIU 106a may once again be directed to traffic manager 108b instead of traffic manager 108a. However, before the switchover is complete, some Ethernet frames in the switched-over flows may have already been processed and queued for transmission from traffic manager 108a. These already-queued Ethernet frames may be communicated from traffic manager 108a after the post-switchover Ethernet frames in the same flows are communicated from traffic manager 108b in the newly re-inserted PIU 106b. Accordingly, the already-queued Ethernet frames in traffic manager 108a must be discarded to avoid the transmission of out-of-sequence Ethernet frames in a flow. Application-specific integrated circuits (ASICs), or a large field-programmable gate arrays (FPGAs) may perform “garbage collection,” i.e., discard the potentially out-of-sequence Ethernet frames by reclaiming the allocated buffers. However, a more efficient and cost-effective means of discarding Ethernet frames after a switchover of traffic manager resources may be desired.

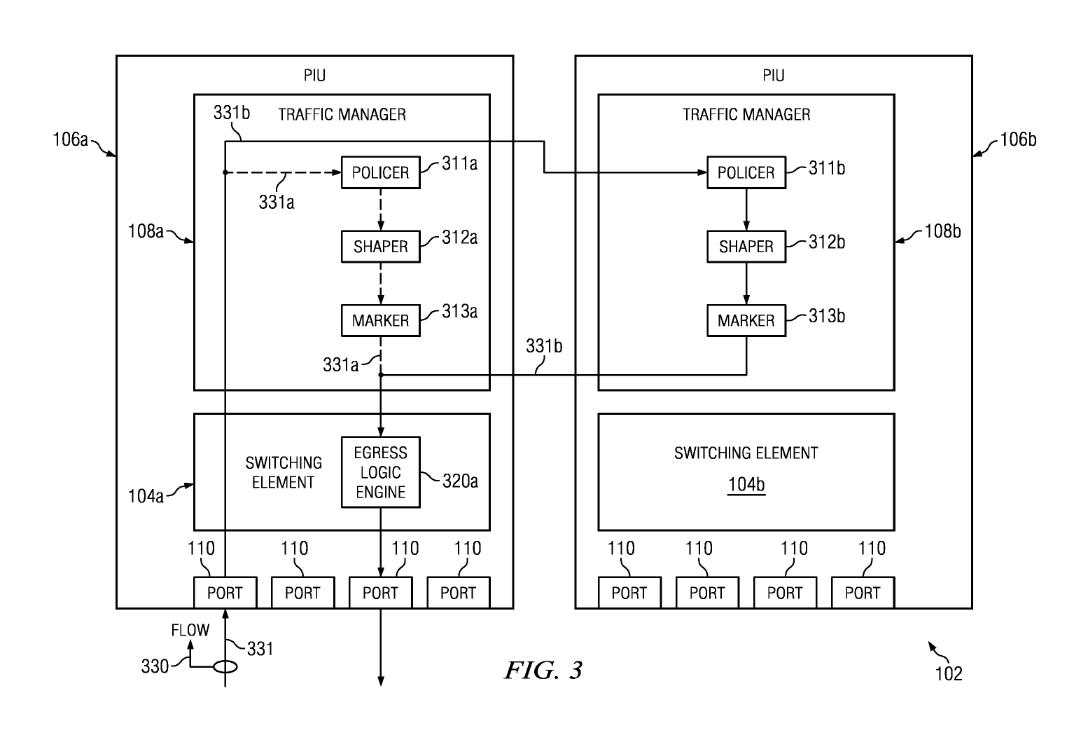

FIG. 3 illustrates a block diagram of portions of an example network element 102 including the path of a flow subject to a switchover of traffic manager resources as network element 102 transitions from one-PIU operation to two-PIU operation, in accordance with certain embodiments of the present disclosure. In some embodiments, the functional blocks illustrated in FIG. 3 may be implemented partially or fully in hardware, software, or firmware. Switching elements 104a-b and traffic managers 108a-b may include processors and/or other integrated circuits that may be configured to execute such software or firmware. In some embodiments, the functional blocks illustrated in FIG. 3 may be implemented partially or fully by an ASIC or an FPGA.

As shown in FIG. 3, network element 102 may include PIU 106a including switching element 104a and traffic manager 108a. During normal two-PIU operation, network element 102 may also include PIU 106b including switching element 104b and traffic manager 108b.

As described above, traffic manger 108b may handle some flows received by PIU 106a and PIU 106b during normal two-PIU operation, and traffic manager 108a may handle other flows received by PIU 106a and PIU 106b during normal two-PIU operation. Accordingly, each flow in network element 102 may have a designated “primary” traffic manager and a designated “secondary” traffic manager. For example, during two-PIU operation, a flow's primary traffic manager may be the traffic manager that is actively managing that flow. On the other hand, a flow's secondary traffic manager may be the traffic manager that is on standby for that flow during two-PIU operation, but may take over actively managing the flow if the the network element enters one-PIU operation due to the removal of the PIU that holds the flow's primary traffic manager.

As depicted in FIG. 3, flow 330 may be an example of one flow that is received on PIU 106a, processed by traffic manager 108b during normal two-PIU operation, and processed by traffic manager 108a if PIU 106b is removed. Accordingly, traffic manager 108b may be the primary traffic manager for flow 330, and traffic manager 108a may be the secondary traffic manager for flow 330.

As illustrated in FIG. 3, switching element 104a may receive flow 330 via internal flow path 331. Internal flow path 331 may diverge depending on whether the network element is in one-PIU operation or in two-PIU operation. Internal flow path 331a may illustrate the internal path of flow 330 during one-PIU operation, and internal flow path 331b may illustrate the internal path of flow 330 during two-PIU operation.

During one-PIU operation with PIU 106a, flow 330 may be communicated along internal flow path 331a to flow 330's secondary traffic manager, traffic manager 108a. Inside traffic manager 108a, policer 311a may perform traffic policing. For example, traffic exceeding a service-level agreement may be discarded immediately, marked as non-compliant, or left as-is, depending on an administrative policy and the characteristics of the excess traffic. Next, shaper 312a may perform traffic shaping. For example, shaper 312a may control traffic flows in order to optimize or guarantee performance, improve latency, and/or increase usable bandwidth by delaying frames of traffic that meet certain criteria. More specifically, shaper 312a may manage flow 330 such that flow 330 conforms to some predetermined constraint (e.g., a service-level agreement or traffic profile).

Ethernet frames in flow 330 may each include an identifier, for example a virtual local area network (VLAN) tag, that identifes the flow to which the individual Ethernet frames belong. Each unique flow handled by network element 102 may be associated with a VLAN tag unique to that flow. When an Ethernet frame enters a network element, the network element may attach a metatag to the Ethernet frame. The metatag may include an array of bits that may carry information about the Ethernet frame (i.e., metadata) for processing at, for example, a switching element and/or a traffic manager. The information carried by a metatag may be referred to as metadata. Though a metatag may be designated for a specific purpose, the metatag's bits may be appropriated for other purposes as described below.

Marker 313a may generate a class marker for each processed Ethernet frame in flow 330. The class marker may indicate that the processed Ethernet frames in flow 330 were processed by the traffic manager that is the secondary traffic manager for flow 330. In some embodiments, marker 313a may appropriate an otherwise unused bit in a metatag attached to Ethernet frames in flow 330 for this purpose. Some metadata carried in the Ethernet frame's metatag may have a use on ingress, but may not have a use on egress, and for the purposes of this disclosure, such metadata may be called “ingress metadata.” An example of ingress metadata may be the source(mod) and source(port) bits of an Ethernet frame's metatag. The bits in the source(mod) and source(port) fields may indicate the module and port where a specific flow entered the system. This information may be used by a switching element and/or a traffic manager on ingress, but may have no use in the egress direction. Accordingly, marker 313a in traffic manager 108a may appropriate one or more bits from the source(mod) and/or source(port) bits in an Ethernet frame's metatag and use the one or more bits in the egress direction as a class marker indicating that those particular Ethernet frames in flows 330 were processed by the traffic manager that is designated as the secondary traffic manager for flow 330 during normal two-PIU operation.

Traffic managers 108a and 108b may each include a table storing static information identifying each unique flow in network element 102 by a unique VLAN tag. The stored information may indicate, for each flow in network element 102, which of the two traffic managers is designated as the primary traffic manager for that flow, and which of the two traffic managers is designated as the secondary traffic manager for that flow. Based on the stored information, the respective class markers for Ethernet frames from any flow in network element 102 may be set according to whether the traffic manager that processed the Ethernet frame is designated as the primary traffic manager for the flow or is designated as the secondary traffic manager for the flow. For example, marker 313a may set class markers to logical 1 for all processed Ethernet frames in flows, including flow 330, for which traffic manager 108a is designated in the table as the secondary traffic manager. On the other hand, marker 313a may set class markers to logical 0 for all processed Ethernet frames in flows for which traffic manager 108a is designated in the table as the primary traffic manager.

After policing, shaping, and marking the Ethernet frames in the flow 330 during one-PIU operation, traffic manager 108a may communicate the Ethernet frames in flow 330 to switching element 104a for egress from network element 102.

As described above, when PIU 106b is inserted in network element 102, network element 102 may enter two-PIU operation. Accordingly, flow 330 may be switched over from being processed by traffic manager 108a to being processed by traffic manager 108b. During two-PIU operation, flow 330 may be communicated to traffic manager 108b along internal path 331b. In traffic manager 108b, policer 311b and shaper 312b may police and shape flow 330 in the same manner as described above for traffic manager 108a during one-PIU operation. But, whereas marker 313a may have set the class markers of Ethernet frames in flow 330 to logical 1 to indicate that the Ethernet frames had been processed by the traffic manager that is designated as the secondary traffic manager for flow 330, marker 313b may set the class markers of the post-switchover Ethernet frames in flow 330 to logical 0 to indicate that the post-switchover Ethernet frames have been processed by the traffic manager that is designated as the primary traffic manager for flow 330.

After the post-switchover Ethernet frames in flow 330 have been policed, shaped, and marked at traffic manager 108b, the post-switchover Ethernet frames in flow 330 may be communicated to egress logic engine 320a in switching element 104a along internal path 331b.

By the time the switchover is complete, some Ethernet frames in flow 330 may have already been processed by traffic manager 108a and may be queued for transmission to switching element 104a in a buffer of traffic manager 108a. These already-queued Ethernet frames may be communicated to switching element 104a after the post-switchover Ethernet frames in flow 330 are communicated from traffic manager 108b to switching element 104a. Accordingly, the already-queued Ethernet frames from traffic manager 108a must be discarded in order to avoid the transmission of out-of-sequence Ethernet frames. As described below, the class markers assigned by markers 313a and 313b provide an efficient means for identifying and discarding the potentially out-of-sequence Ethernet frames.

As described above, Ethernet frames in flows having traffic manager 108a designated as their secondary traffic manager, including flow 330, may receive a class marker of logical 1 when processed by traffic manager 108a during one-PIU operation. After PIU 106b is inserted and network element 102 enters two-PIU operation, the post-switchover Ethernet frames in the same flows, having traffic manager 108b designated as their primary traffic manager, may receive a class marker of logical 0 when processed by traffic manager 108b during two-PIU operation. During one-PIU operation, egress logic engine 320a may be instructed to pass Ethernet frames with a class marker of logical 1. But during a transition to two-PIU operation, egress logic engine 320a may be instructed to discard all received Ethernet frames with a class marker of logical 1. Accordingly, the potentially out-of-sequence Ethernet frames received from traffic manager 108a with a class marker of logical 1, including those in flow 330, may be discarded by egress logic engine 320a. On the other hand, post-switchover Ethernet frames received from traffic manager 108b with a class marker of logical 0 may be passed by egress logic engine 320a for normal operation switching, i.e., communication to an egress buffer for transmission from network element 102.

The use of class markers for discarding potentially out-of-sequence Ethernet frames during a switchover from one-PIU operation to two-PIU operation eliminates the need for the costly reclamation of the buffers in which the potentially out-of-sequence frames are located. Further, the disclosed technique allows the frame discard policy to be implemented for all flows with only a single rule at an egress logic engine in a switching element. The static information tables in the traffic managers identify the primary and secondary traffic managers during normal two-PIU operation for each flow in network element 102. The flow-specific information allows the traffic managers to mark Ethernet frames from any flow handled by network element 102 with a simple one-bit class marker indicating whether the Ethernet frames may need to be discarded after a transition from one-PIU operation to two-PIU operation, i.e., whether the Ethernet frames were processed by their designated secondary traffic manager. Because the class markers have the same meaning for each flow in network element 102, the frame discard policy may be implemented for all flows in network element 102 based on only a single rule. As such, the frame discard policy may be implemented for all flows in a network element with minimal device resources.

Though the disclosure describes the implementation of a frame discard policy in the context of the removal and re-insertion of PIU 106b in network element 102, the same frame discard policy as disclosed herein may be implemented in the context of the removal and re-insertion of PIU 106a in network element 102.

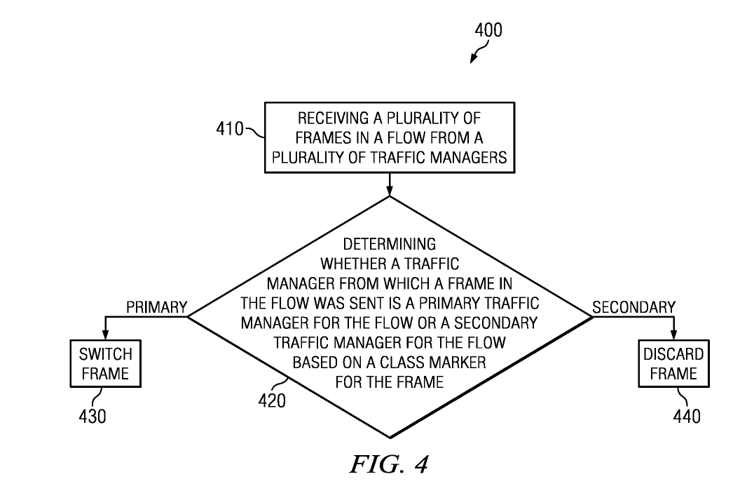

FIG. 4 illustrates a flow chart depicting an example method 400 for discarding Ethernet frames after a network element transitions from one-PIU operation to two-PIU operation.

At step 410, an egress logic engine 320a in switching element 104a may receive a plurality of frames in a flow from a plurality of traffic managers. For example, after a switchover of traffic manager resources for flow 330 from traffic manager 108a to traffic manager 108b, switching element 104a may receive a plurality of frames from traffic manager 108a that were already queued for transmission from traffic manager 108a before the switchover. The frames from traffic manager 108a may have a class marker set to logical 1. After the switchover, switching element 104a may also receive a plurality of frames in flow 330 from traffic manager 108b in the newly inserted PIU 106b. The frames from traffic manager 108b may have a class marker set to logical 0.

At step 420, egress logic engine 320a may determine whether the traffic manager from which a frame in the flow was sent is a primary traffic manager for the flow or a secondary traffic manager for the flow based on a class marker for the frame. For example, egress logic engine 320a may determine that a frame in flow 330 was received from the secondary traffic manager for flow 330 based on a class marker of logical 1 for the frame. Similarly, egress logic engine 320a may determine that a post-switchover frame in flow 330 was received from the primary traffic manager for flow 330 based on a class marker of logical 0 for the frame.

If at step 420, egress logic engine 320a determines that the frame is from the primary traffic manager for the flow, method 400 may proceed to step 430 where the frame is switched. For example, the frame may be communicated to an egress buffer for transmission from network element 102.

If at step 420, egress logic engine 320a determines that the frame is from the secondary traffic manager for the flow, method 400 may proceed to step 440 where the frame may be discarded.

Although FIG. 4 discloses a particular number of steps to be taken with respect to method 400, method 400 may be executed with greater or lesser steps than those depicted in FIG. 4. In addition, although FIG. 4 discloses a certain order of steps to be taken with respect to method 400, the steps comprising method 400 may be completed in any suitable order.

A component of network 10 may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. For example, logic may perform the functions of egress logic engine 320a in switching element 104a, as well as the functions of policers 311a-b, shapers 312a-b, and markers 313a-b of traffic managers 108a-b. Logic may include hardware, software, and/or other logic. Logic may be encoded in one or more tangible computer readable storage media and may perform operations when executed by a computer. Certain logic, such as a processor, may manage the operation of a component. Examples of a processor include one or more computers, one or more microprocessors, one or more applications, and/or other logic.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

Modifications, additions, or omissions may be made to network 10 without departing from the scope of the invention. The components of network 10 may be integrated or separated. Moreover, the operations of network 10 may be performed by more, fewer, or other components. Additionally, operations of network 10 may be performed using any suitable logic. As used in this document, “each” refers to each member of a set or each member of a subset of a set.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method comprising:
receiving a plurality of frames in a flow from a plurality of traffic managers;
determining whether a traffic manager from which a frame in the flow was sent is a primary traffic manager for the flow or a secondary traffic manager for the flow based on a class marker for the frame;
switching the frame if the frame is from the primary traffic manager for the flow; and
discarding the frame if the frame is from the secondary traffic manager for the flow.

2. The method of claim 1, wherein a first class-marker setting indicates that the frame is from the primary traffic manager for the flow and a second class-marker setting indicates that the frame is from the secondary traffic manager for the flow.

3. The method of claim 2, further comprising instructing a switching element with one rule to discard all frames from all flows in a network element with class markers set to the second setting.

4. The method of claim 1, wherein the primary traffic manager is the normally active traffic manager for a flow and the secondary traffic manager is the standby traffic manager for a flow.

5. The method of claim 1, further comprising setting the class marker for the frame based on static information stored in the traffic manager, the information stored in the traffic manager designating the traffic manager as the primary traffic manager or the secondary traffic manager for each flow in a network element.

6. The method of claim 1, further comprising writing the class marker over at least one bit in a metatag attached to the frame at the traffic manager.

7. The method of claim 6, wherein the least one bit comprised at least a portion of a source(mod) marker in the metatag prior to being overwritten by the class marker.

8. A system comprising:
a plurality of traffic managers; and
a switching element configured to:
receive a plurality of frames in a flow from the plurality of traffic managers;
determine whether a traffic manager from which a frame in the flow was sent is a primary traffic manager for the flow or a secondary traffic manager for the flow based on a class marker for the frame;
switch the frame if the frame is from the primary traffic manager for the flow; and
discard the frame if the frame is from the secondary traffic manager for the flow.

9. The system of claim 8, wherein a first class-marker setting indicates that the frame is from the primary traffic manager for the flow and a second class-marker setting indicates that the frame is from the secondary traffic manager for the flow.

10. The system of claim 9, wherein the switching element is further configured to, based on one rule, discard all frames from all flows in a network element with class markers set to the second setting.

11. The system of claim 8, wherein the primary traffic manager is the normally active traffic manager for a flow and the secondary traffic manager is the standby traffic manager for a flow.

12. The system of claim 8, wherein the traffic manager is configured to set the class marker for the frame based on static information stored in the traffic manager, the information stored in the traffic manager designating the traffic manager as the primary traffic manager or the secondary traffic manager for each flow in a network element.

13. The system of claim 8, wherein the class marker occupies at least one bit in a metatag attached to the frame.

14. The system of claim 13, wherein the least one bit comprised at least a portion of a source(mod) marker in the metatag prior to being overwritten by the class marker.

15. Logic embodied in non-transitory computer readable memory and operable, when executed, to:
receive a plurality of frames in a flow from a plurality of traffic managers;
determine whether a traffic manager from which a frame in the flow was sent is a primary traffic manager for the flow or a secondary traffic manager for the flow based on a class marker for the frame;
switch the frame if the frame is from the primary traffic manager of the flow; and
discard the frame if the frame is from the secondary traffic manager of the flow.

16. The logic of claim 15, wherein a first class-marker setting indicates that the frame is from the primary traffic manager for the flow and a second class-marker setting indicates that the frame is from the secondary traffic manager for the flow.

17. The logic of claim 16, the logic further operable, when executed, to instruct a switching element with one rule to discard all frames from all flows in a network element with class markers set to the second setting.

18. The logic of claim 15, wherein the primary traffic manager is the normally active traffic manager for a flow and the secondary traffic manager is the standby traffic manager for a flow.

19. The logic of claim 15, the logic further operable, when executed, to set the class marker for the frame based on static information stored in the traffic manager, the information stored in the traffic manager designating the traffic manager as the primary traffic manager or the secondary traffic manager for each flow in a network element.

20. The logic of claim 15, the logic further operable, when executed, to write the class marker over at least one bit in a metatag attached to the frame.
